(19) United States
(12) Patent Application Publication
(10) Pub. No.: US 2015/0036316 A1
(43) Pub. Date: Feb. 5, 2015

(54) WHITE LIGHT-EMITTING DIODE WITH HIGH UNIFORMITY AND WIDE ANGLE INTENSITY DISTRIBUTION

(71) Applicant: National Taiwan University, Taipei (TW)

(72) Inventors: CHING-FUH LIN, Taipei (TW); Pin-Chun SHEN, Taipei (TW)

(73) Assignee: National Taiwan University, Taipei (TW)

(21) Appl. No.: 14/058,239

(22) Filed: Oct. 19, 2013

(30) Foreign Application Priority Data
Aug. 1, 2013 (TW) 102127683

(51) Int. Cl. F21V 13/02; F21K 99/00; F21V 29/00

(52) U.S. Cl. CPC F21V 13/02; F21V 29/22; F21V 29/246; F21K 9/56; Y10S 977/833; B82Y 99/00
USPC 362/84; 977/833; 977/834

(57) ABSTRACT

The present invention relates to a white light-emitting diode with high uniformity and wide angle intensity distribution, and particularly relates to a color temperature tunable white light-emitting diode with high uniformity and wide angle intensity distribution. A nano-phosphor material is coated on one surface of a lampshade of the white light-emitting diode to form a white light phosphor layer for providing a stable white light with high uniformity, wide angle intensity distribution, and good illuminance. Furthermore, the color temperature of the white light-emitting diode can be adjusted by changing the ratio of compositions of white light phosphor layer.

### CROSS REFERENCE

This application claims priority from Taiwan Patent Application No. 102127683, filed Aug. 1, 2013, the content of which are hereby incorporated by reference in their entirety for all purposes.

### BACKGROUND OF THE INVENTION

1. Field of the Invention

The present invention relates to a white light-emitting diode with high uniformity and wide angle intensity distribution, and particularly relates to a color temperature tunable white light-emitting diode with high uniformity and wide angle intensity distribution.

2. Description of the Prior Art

Now, the white LED is fabricated by adhering a yellow phosphor (or a green phosphor or a red phosphor) on a light emitting surface of a blue LED. FIG. 1 shows a conventional white LED 10. The white LED 10 is composed of a LED (such as a blue LED) 14, a lead frame 16, a sealant 12 formed by mixing a phosphor (such as yellow phosphor, green phosphor, or red phosphor) with a glue, and a lampshade 18. The LED 14 is deposed on the lead frame 16, and the LED 14 is electrically connected with the leas frame 16 though wire bonding. The LED 14 is sealed on the lead frame 16 by the sealant 12, and the lampshade 18 covers the LED 14, the sealant 12, and the lead frame 16.

However, the conventional white LED 10 has many shortcomings. First, a light emitted from the LED 14 is directional. The white light formed by the conventional white LED is directional because the light emitted from the LED 14 is directional and the sealant 12 formed by mixing a phosphor with a glue is horizontally coated on the light emitting surface of the LED 14. It results in non-uniform intensity of the white light emitted from the conventional white LED 10 at different angles. In the conventional white LED 10, the white light has a highest intensity at the angle directly facing the light emitting surface of the LED 14 and the white light has a lower intensity at other angles which do not directly face the light emitting surface of the LED 14. It means that the intensity of the white light emitted through the top side of the lampshade 18 is strongest and the intensity of the white light emitted through the sides and backside of the lampshade 18 is weaker.

Next, most raw materials of the phosphor used in the conventional white LED 10 are rare earth elements, and most of the phosphors have bigger size than micro-scale. So, when the phosphor is coated on the light emitting surface of the LED 14 to form a phosphor film, the phosphor film has a certain thickness and it is not thin enough. After the phosphor (or phosphor film) is excited by the light emitted from the LED 14 and the light emitted from the phosphor (or phosphor film) is mixed with the light emitted from the LED 14 to form the white light, portion of the white light will be absorbed by phosphor (or phosphor film) when the white light pass through the phosphor film. It is because the phosphor film is not thin enough to prevent the phosphor film from absorbing the white light generated by the conventional white LED 10. Therefore, the phosphor (or phosphor film) has an absorbing effect to the white light generated by the conventional white LED 10 and the white light generated by the conventional white LED 10 becomes weaker. Besides, it is difficult to precisely control the thickness of the phosphor film to form the phosphor film having a special or predetermined thickness, such as the thickness is thin enough to prevent the phosphor film from absorbing the white light generated by the conventional white LED 10, because most of phosphors used in the conventional white LED 10 have bigger size than micro-scale.

Furthermore, in the conventional white LED 10, a blue LED is often adopted to be the LED 14 and a yellow phosphor is adopted to be the phosphor in sealant 12. The white light of the conventional white LED 10 is formed by mixing a blue light emitted from the blue LED and a yellow light generated by exciting the yellow phosphor with the blue light. The blue light has different intensity at different angles because the blue light emitted from the blue LED is directional. Therefore, in the white light emitted from the conventional white LED 10, the intensity of the blue light at different angles is not the same. It results in non-uniform color temperature of the white light at different angles. For example, the area (in the white light) having more blue light has higher color temperature, and the area (in the white light) having less blue light has lower color temperature.

Besides, in the conventional white LED 10, the phosphor (such as a yellow phosphor) is adhered on the LED 14 (such as a blue LED). Therefore, once the conventional white LED 10 is used for a long time, the temperature of the LED 14 (such as a blue LED) will rise and the temperature of the phosphor will rise following the temperature rising of the LED 14. The temperature rising of the phosphor results in destruction or invalidation of the phosphor. Therefore, the luminous efficiency and the light color of the phosphor are seriously influenced, and the conventional white LED 10 can not be used for a long time and provide a stable white light because of the serious influence of the luminous efficiency and the light color of the phosphor. Furthermore, in the conventional white LED 10, the white light emitted from the LED 14 is shielded by the LED 14 itself and the pedestal of the conventional white LED 10 because the phosphor (such as a yellow phosphor) is horizontally coated on the LED 14 (such as a blue LED). Therefore, the illumination area of the conventional white LED 10 is not wide enough to provide an all-dememtional illumination or a 360 degree illumination.

Therefore, it has a need of a white light-emitting diode with high uniformity and wide angle intensity distribution, which can provide a stable white light with big illumination area, uniform intensity and color temperature, and good illuminance.

### SUMMARY OF THE INVENTION

In view of the foregoing, one object of the present invention is to provide a white light-emitting diode with high uniformity and wide angle intensity distribution for overcoming above-mentioned shortcomings to provide a stable white light with big illumination area, uniform intensity and color temperature, and good illuminance. Further, the color temperature of the white light generated by the white light-emitting diode can be adjusted.

According to one of the objects above, a white light-emitting diode with high uniformity and wide angle intensity distribution is disclosed herein. The white light-emitting diode with high uniformity and wide angle intensity distribution comprises a base, a UV LED array, a lampshade, and a white light phosphor layer wherein the UV LED array is deposed on the base, the lampshade is integrated with the base to form a space inside the combination of the lampshade for covering and holding (or containing) the UV LED array therein, and the white light phosphor layer is coated on one surface of the lampshade. The white light phosphor layer is formed by coating a nano-phosphor material on the surface of the lampshade. The white light phosphor layer (or the nano-phosphor material) can be excited by a UV light to form many pointolites (or point light sources) arranged on the surface of the lampshade. Therefore, the white light-emitting diode can provide a stable white light with big illumination area, uniform intensity and color temperature, and good illuminance. Furthermore, the UV LED array comprises two set of UV LEDs, which emit UV lights having different wavelengths respectively, for controlling or adjusting color temperature of the white light-emitting diode. Or, the color temperature of the white light-emitting diode can be adjusted by changing the ratio of compositions of white light phosphor layer.

Therefore, the present invention provides a white light-emitting diode with high uniformity and wide angle intensity distribution. In the white light-emitting diode, there are many pointolites (or point light sources) formed on the lampshade by the white light phosphor layer, which is formed by coating the nano-phosphor material on the surface of the lampshade, when a UV light illuminates the white light phosphor layer. Therefore, the white light-emitting diode can provide a stable white light with big illumination area, uniform intensity and color temperature, and good illuminance. Further, the color temperature of the white light generated by the white light-emitting diode can be adjusted by different combinations of the UV LEDs respectively having different wavelengths, and different ratio of compositions of white light phosphor layer.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a drawing illustrating a conventional white LED.

FIG. 2A is a drawing illustrating a white light-emitting diode with high uniformity and wide angle intensity distribution having a single layer structure of the white light phosphor layer in accordance with one embodiment of the present invention.

FIG. 2B is a drawing illustrating a white light-emitting diode with high uniformity and wide angle intensity distribution having a multilayer structure of the white light phosphor layer in accordance with one embodiment of the present invention.

FIG. 3A is a drawing illustrating a white light-emitting diode with high uniformity and wide angle intensity distribution having a single layer structure of the white light phosphor layer in accordance with another embodiment of the present invention.

FIG. 3B is a drawing illustrating a white light-emitting diode with high uniformity and wide angle intensity distribution having a multilayer structure of the white light phosphor layer in accordance with another embodiment of the present invention.

FIG. 4 is a drawing illustrating a white light-emitting diode with high uniformity and wide angle intensity distribution in accordance with still another embodiment of the present invention.

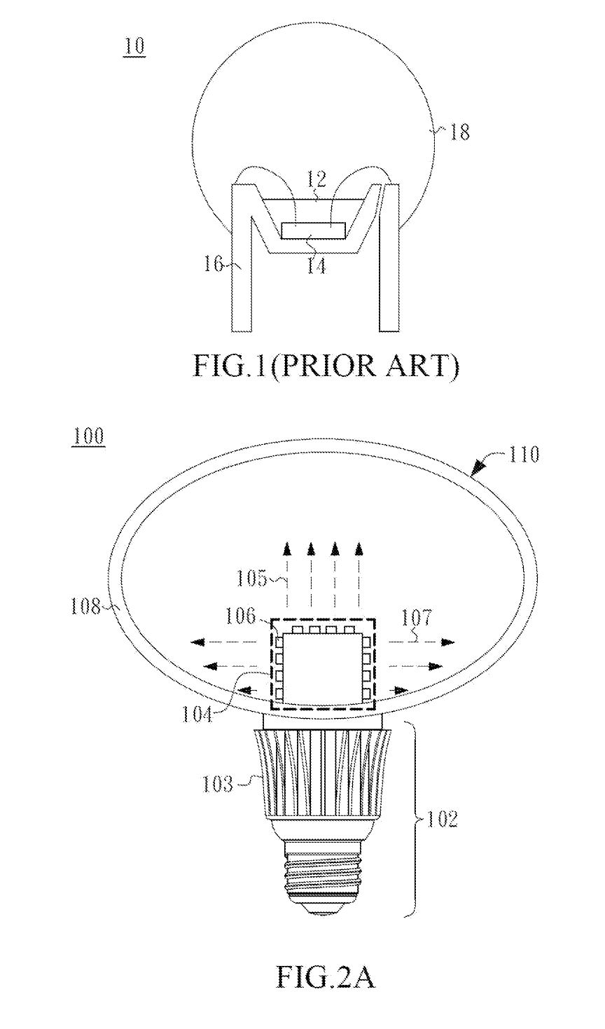

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components. Although specific embodiments have been illustrated and described, it will be appreciated by those skilled in the art that various modifications may be made without departing from the scope of the present invention, which is intended to be limited solely by the appended claims.

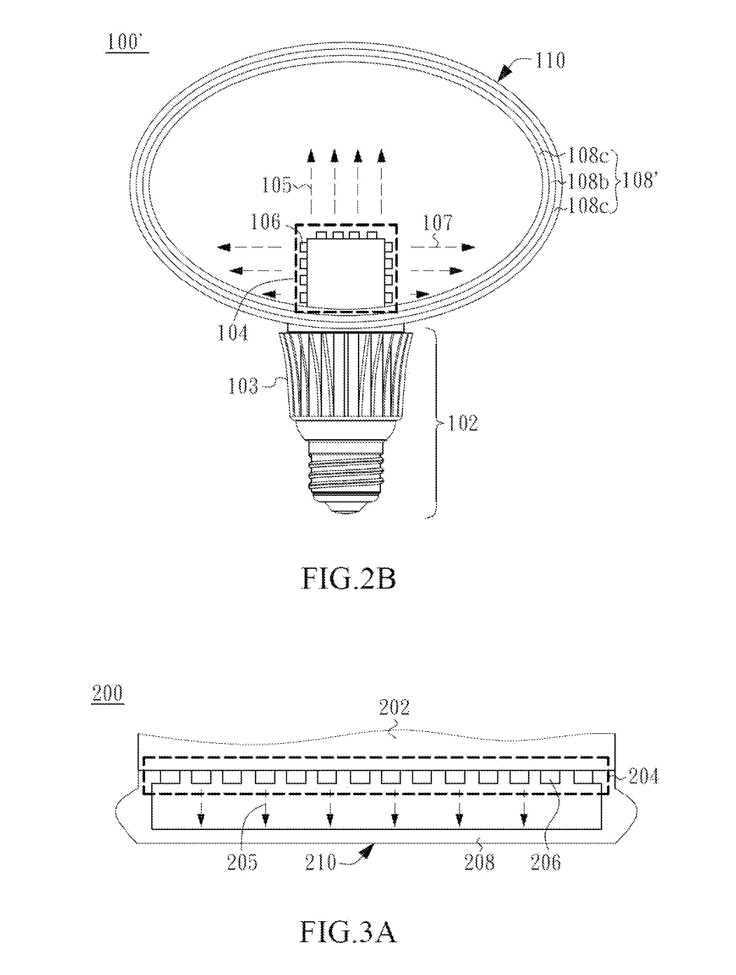

FIG. 2A is a drawing illustrating a white light-emitting diode 100 with high uniformity and wide angle intensity distribution having a single layer structure of the white light phosphor layer in accordance with one embodiment of the present invention. Referring to FIG. 2A, the white light-emitting diode 100 with high uniformity and wide angle intensity distribution comprises a base 102, a UV LED array 104, a white light phosphor layer 108, and a lampshade 110. The UV LED array 104 is deposed on the base 102. The lampshade 110 is integrated or combined with the base 102 to form a space inside the combination of the lampshade 110 and the base 102 wherein the UV LED array 104 is covered and held (or contained) in the space. The white light phosphor layer 108 is coated on one surface of the lampshade 110, for example inner surface of the lampshade 110 or the outer surface of the lampshade 110.

The base 102 comprises a heat dissipation device for quickly transferring the heat, which is generated when the UV LED array 104 emit UV lights, to external environment. It prevents the UV LED array 104 (or the white light-emitting diode 100) from break or damage caused by high temperature. As shown in FIG. 2A, the heat dissipation device maybe a heat sink deposed below the UV LED array 104 or around the UV LED array 104, but not limits. In other embodiment of the present invention, various kinds of the heat dissipation device, for example a heat dissipation paint, a carbon nanotube, or a copper-aluminum alloy, can be adopted to be deposed below or around the UV LED array 104 for heat dissipation.

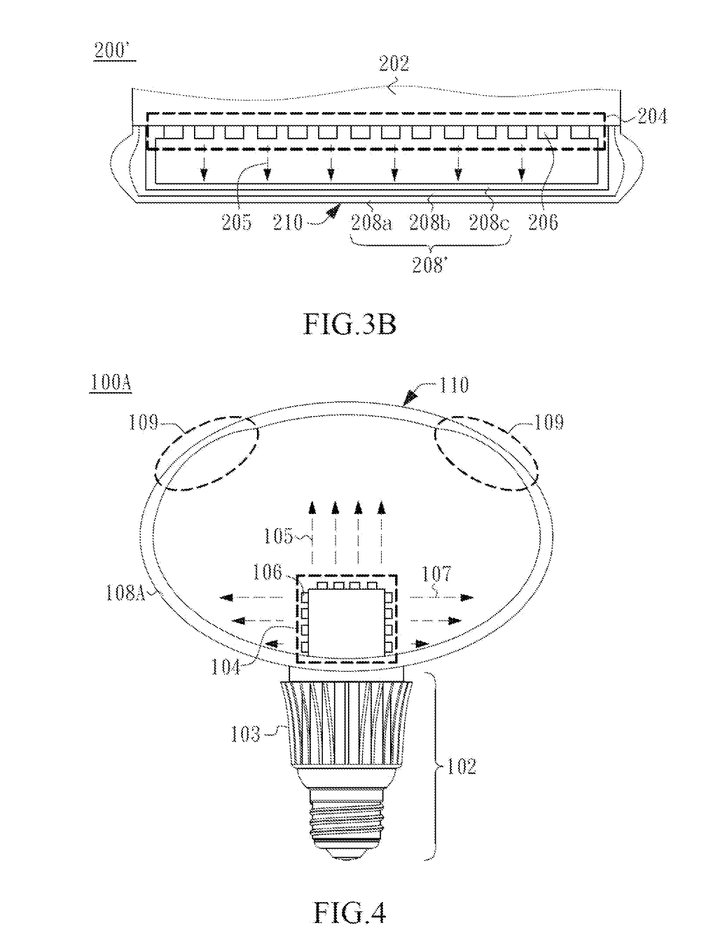

The UV LED array 104 comprises a plurality of UV LEDs 106 and the UV LEDs 106 are arranged on the base 102 to form the UV LED array 104. Although the UV LEDs 106 showed in FIG. 2A are arranged to form a n-shaped array, but not limits. In other embodiment of the present invention, the UV LEDs 106 maybe arranged to form a linear array (as shown in FIG. 3A and FIG. 3B), or the UV LEDs 106 maybe arranged to form an array having various shapes or patterns, for example a n-shaped array, a semicircular array, or a circular array, according to various requirements. All of the UV LEDs 106 can emit UV lights having wavelength in range of 100 nm to 399 nm. The UV LED array 104 maybe comprises a single set of the UV LEDs 106, which emit UV lights having a special or predetermined wavelength, and the UV LED array 104 is constructed only from the set of the UV LEDs 106. Therefore, all of the UV LEDs 106 in the UV LED array 104 emit the UV lights having the same wavelength, for example 365 nm, 375 nm, 390 nm, or other wavelength in the range of wavelength. Or, the UV LED array 104 maybe comprises a two or more sets of the UV LEDs 106, which emit UV lights having different wavelengths, and the UV LED array 104 is constructed from many sets (such as two sets) of the UV LEDs 106. Taking the UV LED array 104 constructed from two sets of the UV LEDs 106 as an example, one of the two sets of the UV LEDs 106 emit the UV light having first wavelength, and another of the two sets of the UV LEDs 106 emit the UV light having second wavelength. The first wavelength is different from the second wavelength. Therefore, the UV LED array 104 can simultaneously emit two or more kinds of the UV lights having different wavelengths for controlling and adjusting the color temperature of the white light emitted from or generated by the white light-emitting diode 100.

The lampshade 110 is hard lampshade made of glass, Poly(methyl methacrylate) (PMMA), Polyethylene terephthalate (PET), PolyproPylene (PP), Polyurethane (PU), Polyethylene (PE), Polycarbonate (PC), or Polystyrene (PS), or the lampshade 110 is soft lampshade made of a flexible material. Although, in the embodiment showed in FIG. 2A, the lampshade 110 has an elliptic shape, but not limits. In other embodiment of the present invention, the lampshade 110 maybe have a planar shape (as showed in FIG. 3A and FIG. 3B) or have various kinds of shapes, for example a spherical shape or a circular-arc shape. However, it is not a limit. The lampshade 110 of the present invention can have various kinds of shapes according to requirements.

The white light phosphor layer 108 is a film formed by coating a nano-phosphor material on the surface (inner surface or outer surface) of the lampshade 110. The white light phosphor layer 108 can be excited by the UV light, which is emitted from the UV LED 104 or the UV LEDs 106, to form a white light. In one embodiment of the present invention, the nano-phosphor material, of which the white light phosphor layer 108 is made, comprises a blue light organic material and a zinc oxide nano structure. It means that the white light phosphor layer 108 is made of the blue light organic material and the zinc oxide nano structure. The blue light organic material is an organic material which can be excited by a UV light to emit a blue light, for example poly(fluorine) (PF), Alq2. Aromatic oligomer containing pyrimidine, Fluorene Oligomers, Aromatic oligomer containing Furan, distearyl allylene (DSA), stilbenes, or coumarins. The zinc oxide nano structure is a zinc oxide nanoparticle, a zinc oxide nanoisland, a zinc oxide nanorod, a zinc oxide nanoline, a zinc oxide nanotube, or a zinc oxide nano-porous structure. When a UV light emit to the interfacial defects formed by the blue light organic material and the zinc oxide nano structure, a green light is generated by recombination of electrons at interfacial defects which are formed by the blue light organic material and the zinc oxide nano structure. Therefore, when the UV light, which is emitted from the UV LED 104 or the UV LEDs 106, emits to the white light phosphor layer 108 coated on the lampshade 110, the white light phosphor layer 108 is excited to simultaneously emit a blue light and a green light. And then, the blue light and the green light are mixed with each other to form a white light. Therefore, the white light-emitting diode 100 can emit a white light.

The nano-phosphor material made of the blue light organic material and the zinc oxide nano structure is coated on the surface (inner surface or outer surface) of the lampshade 110 by spin coating, dip coating, ink printing, thermal evaporation, sputtering, spray coating, or roll-to-roll, and then, the nano-phosphor material coated on the surface (inner surface or outer surface) of the lampshade 110 is annealed to form the white light phosphor layer 108 on the surface (inner surface or outer surface) of the lampshade 110. The color temperature of the white light emitted from the white light phosphor layer 108 is influenced by the ratio (or the intensity) of the blue light and the green light in the white light because the white light phosphor layer 108 is made of the blue light organic material and the zinc oxide nano structure, and the white light emitted from the white light phosphor layer 108 is formed by mixing the blue light, which is generated by exciting the blue light organic material with the UV light, and the green light, which is generated by exciting interfacial defects formed by the blue light organic material and the zinc oxide nano structure with the UV light. The more blue light the white light emitted from the white light phosphor layer 108 contains, the higher color temperature the white light emitted from the white light phosphor layer 108 has. The ratio of the blue light and the green light in the white light emitted from the white light phosphor layer 108 is influenced by the ratio of the blue light organic material and the zinc oxide nano structure in the nano-phosphor material (or the white light phosphor layer 108). The higher ratio of the blue light organic material the white light phosphor layer 108 (or the nano-phosphor material) contains, the higher ratio (or intensity) of the blue light the white light, which is generated by exciting the white light phosphor layer 108 with the UV light, has. Therefore, the white light emitted from the white light-emitting diode 100 of the present invention can have higher color temperature. Besides, the ratio of the green light in the white light emitted from the white light phosphor layer 108 is influenced by the number of the interfacial defects formed by the blue light organic material and the zinc oxide nano structure in the nano-phosphor material (or the white light phosphor layer 108). The more interfacial defects formed by the blue light organic material and the zinc oxide nano structure the white light phosphor layer 108 has, the higher ratio (or intensity) of the green light the white light, which is generated by exciting the white light phosphor layer 108 with the UV light, has. Therefore, the white light emitted from the white light-emitting diode 100 of the present invention can have lower color temperature. The number of the interfacial defects formed by the blue light organic material and the zinc oxide nano structure is influenced by the temperature of annealing, and so the temperature of annealing further influences and changes the intensity of the green light. The higher the temperature of annealing is, the more interfacial defects formed by the blue light organic material and the zinc oxide nano structure the white light phosphor layer 108 has and the higher intensity the green light has. By this way, the color temperature of the white light emitted from the white light-emitting diode 100 of the present invention can be lowered. Therefore, the intensity of the green light can be controlled and changed by changing the temperature of annealing, and further the changing of the green light in the white light can be controlled by changing the temperature of annealing. By this way, the color temperature of the white light emitted from the white light-emitting diode 100 of the present invention can be controlled and adjusted. Therefore, the color temperature of the white light emitted from the white light-emitting diode 100 of the present invention can be adjusted efficiently and the emitting character (such as CRI) of the white light-emitting diode 100 of the present invention can be changed by changing and adjusting the ratio of the blue light organic material and the zinc oxide nano structure in the white light phosphor layer 108 (or the nano-phosphor material) and the temperature of annealing the blue light organic material and the zinc oxide nano structure in the white light phosphor layer 108 (or the nano-phosphor material).

Or, in another embodiment of the present invention, the nano-phosphor material, of which the white light phosphor layer 108 is made, comprises a blue light organic material and a zinc oxide nano structure, and a metal-ion-doped zinc sulfide nanoparticle in which the metal ion is capable of being used as a luminous center of a red light. It means that the white light phosphor layer 108 is made of the blue light organic material, the zinc oxide nano structure, and the metal-ion-doped zinc sulfide nanoparticle in which the metal ion is capable of being used as a luminous center of a red light. The blue light organic material and the zinc oxide nano structure are described above in detail, and so they are not mentioned herein again. In the metal-ion-doped zinc sulfide nanoparticle, in which the metal ion is capable of being used as a luminous center of a red light, the metal ion maybe a manganese ion, iron ion, cobalt ion, copper ion, or other metal ion capable of being used as a luminous center of a red light. The metal ion is preferably a manganese ion. When a UV light illuminates the metal-ion-doped zinc sulfide nanoparticle in which the metal ion is capable of being used as a luminous center of a red light, the metal ions capable of be used as a luminous center of a red light are used as luminous centers of red light by electronic transitions of these metal ions. For example electronic transition 4T1->6A1 of a manganese ion can be used as a luminous center of a red light by electronic transition 4T1->6A1 and manganese ion can emit a red light by electronic transition 4T1->6A1. Therefore, when the UV LED array 104 (or the UV LEDs 106) emits UV light(s) to the white light phosphor layer 108 coated on the lampshade 110, the white light phosphor layer 108 is excited by the UV light(s) to emit (or generate) a blue light, a green light, and a red light simultaneously. And then, the blue light, the green light, and the red light are mixed with each other for form a white light. Therefore, the white light-emitting diode 100 can emit a white light. The metal-ion-doped zinc sulfide nanoparticle is prepared by hydrothermal method, solid-state reaction, spin coating, dip coating, electrochemical method, precipitation in liquid phase, thermal evaporation, chemical vapor deposition, molecular beam epitaxy, metal-organic chemical vapor deposition (MOCVD), or pulsed laser deposition (PLD).

The nano-phosphor material made of the blue light organic material, the zinc oxide nano structure, and the metal-ion-doped zinc sulfide nanoparticle in which the metal ion is capable of being used as a luminous center of a red light is coated on the surface (inner surface or outer surface) of the lampshade 110 by spin coating, dip coating, ink printing, thermal evaporation, sputtering, spray coating, or roll-to-roll, and then, the nano-phosphor material coated on the surface (inner surface or outer surface) of the lampshade 110 is annealed to form the white light phosphor layer 108 on the surface (inner surface or outer surface) of the lampshade 110. The color temperature of the white light emitted from the white light phosphor layer 108 is influenced by the ratio (or the intensity) of the blue light, the green light, and the red light in the white light because the white light phosphor layer 108 is made of the blue light organic material, the zinc oxide nano structure, and the metal-ion-doped zinc sulfide nanoparticle in which the metal ion is capable of being used as a luminous center of a red light, and the white light emitted from the white light phosphor layer 108 is formed by mixing the blue light, which is generated by exciting the blue light organic material with the UV light, the green light, which is generated by exciting the interfacial defects formed by the blue light organic material and the zinc oxide nano structure with the UV light, and the red light, which is generated by exciting the metal-ion-doped zinc sulfide nanoparticle with the UV light. The more blue light the white light emitted from the white light phosphor layer 108 contains, the higher color temperature the white light emitted from the white light phosphor layer 108 has. The more green light and red light the white light emitted from the white light phosphor layer 108 contains, the lower color temperature the white light emitted from the white light phosphor layer 108 has. The methods of adjusting the ratio of the blue light and the green light in the white light emitted from the white light phosphor layer 108 are described above in detail, and so they are not mentioned herein again. The ratio of the red light in the white light emitted from the white light phosphor layer 108 can be adjusted by controlling and adjusting the ratio of the metal-ion-doped zinc sulfide nanoparticle in white light phosphor layer 108 or (the nano-phosphor material). The higher ratio of the metal-ion-doped zinc sulfide nanoparticle the white light phosphor layer 108 (or the nano-phosphor material) contains, the higher ratio (or intensity) of the red light the white light, which is generated by exciting the white light phosphor layer 108 with the UV light, has. By this way, the white light emitted from the white light-emitting diode 100 of the present invention can have lower color temperature. Therefore, the ratio (or intensity) of the blue light, the green light, and the red light in the white light emitted from the white light-emitting diode 100 can be adjusted by controlling and adjusting the ratio of the blue light organic material, the zinc oxide nano structure, and the metal-ion-doped zinc sulfide nanoparticle in the white light phosphor layer 108 (or the nano-phosphor material) and the temperature of annealing the blue light organic material, the zinc oxide nano structure, and the metal-ion-doped zinc sulfide nanoparticle in the white light phosphor layer 108 (or the nano-phosphor material). By these ways, the color temperature of white light emitted from the white light-emitting diode 100 can be controlled and adjusted, and the emitting character (such as CRI) of the white light-emitting diode 100 can be adjusted.

Or, in still another embodiment of the present invention, the nano-phosphor material, of which the white light phosphor layer 108 is made, comprises a blue phosphor (such as ZnO, ZnS, CdSe/ZnS, etc.), a green phosphor (such as (Ba,Sr)SiO₄:Eu²⁺, LuAG:Ce³⁺, etc.), and a red phosphor (such as (Sr,Ba)₂Si₅N₄:Eu²⁺, (Sr,Ca)SiAlN₃:Eu²⁺, etc.). It means that the white light phosphor layer 108 is made of the blue phosphor, thr green phosphor, and the red phosphor. When a UV light illuminates the blue phosphor, thr green phosphor, and the red phosphor, the blue phosphor is excited to emit a blue light, the green phosphor is excited to emit a gree light, and the red phosphor is excited to emit a red light respectively. Therefore, when the UV light, which is emitted from the UV LED 104 or the UV LEDs 106, emits to the white light phosphor layer 108 coated on the lampshade 110, the white light phosphor layer 108 is excited to simultaneously emit the blue light, the green light, and the red light. And then, the blue light, the green light, and the red light are mixed with each other to form a white light. Therefore, the white light-emitting diode 100 can emit a white light.

The nano-phosphor material made of the blue phosphor, the green phosphor, and the red phosphor is coated on the surface (inner surface or outer surface) of the lampshade 110 by spin coating, dip coating, ink printing, thermal evaporation, sputtering, spray coating, or roll-to-roll for forming the white light phosphor layer 108 on the surface (inner surface or outer surface) of the lampshade 110. The color temperature of the white light emitted from the white light phosphor layer 108 is influenced by the ratio (or the intensity) of the blue light, the green light, and the red light in the white light because the white light phosphor layer 108 is made of the blue phosphor, the green phosphor, and the red phosphor, and the white light emitted from the white light phosphor layer 108 is formed by mixing the blue light, which is generated by exciting the blue phosphor with the UV light, the green light, which is generated by exciting the green phosphor with the UV light, and the red light, which is generated by exciting the red phosphor with the UV light. The more blue light the white light emitted from the white light phosphor layer 108 contains, the higher color temperature the white light emitted from the white light phosphor layer 108 has. The more green light and red light the white light emitted from the white light phosphor layer 108 contains, the lower color temperature the white light emitted from the white light phosphor layer 108 has. When the white light phosphor layer 108 (or the nano-phosphor material) has higher ratio of the blue phosphor, the white light, which is emitted from the white light phosphor layer 108 when the white light phosphor layer 108 is excited with the UV light, has higher ratio (or intensity) of the blue light. Therefore, it results in higher color temperature of the white light emitted from the white light-emitting diode 100 of the present invention. When the white light phosphor layer 108 (or the nano-phosphor material) has higher ratio of the gree phosphor or the red phosphor, the white light, which is emitted from the white light phosphor layer 108 when the white light phosphor layer 108 is excited with the UV light, has higher ratio (or intensity) of the green light or the red light. Therefore, it results in lower color temperature of the white light emitted from the white light-emitting diode 100 of the present invention. Therefore, the ratio (or intensity) of the blue light, the green light, and the red light in the white light emitted from the white light-emitting diode 100 can be adjusted by controlling and adjusting the ratio of the blue phosphor, the green phosphor, and the red phosphor in the white light phosphor layer 108 (or the nano-phosphor material). By this way, the color temperature of white light emitted from the white light-emitting diode 100 can be controlled and adjusted, and the emitting character (such as CRI) of the white light-emitting diode 100 can be adjusted.

As showed in FIG. 2A, the white light phosphor layer 108 in the white light-emitting diode 100 is a single layer structure, such as a film formed by mixing the blue light organic material with the zinc oxide nano structure, a film formed by mixing the blue light organic material, the zinc oxide nano structure, and the metal-ion-doped zinc sulfide nanoparticle in which the metal ion is capable of being used as a luminous center of a red light, or a film formed by mixing the blue phosphor, the green phosphor, and the red phosphor, but not be limited. However, the white light-emitting diode of the present invention maybe a multilayer structure formed by stacking several films. FIG. 2B is a drawing illustrating a white light-emitting diode 100′ with high uniformity and wide angle intensity distribution in accordance with one embodiment of the present invention. Referring to FIG. 2B, the white light-emitting diode 100′ illustrated in FIG. 2B has similar structure with the white light-emitting diode 100 illustrated in FIG. 2A. Like the white light-emitting diode 100 illustrated in FIG. 2A, the white light-emitting diode 100′ illustrated in FIG. 2B also comprises a base 102, a UV LED array 104, a white light phosphor layer 108′ and a lampshade 110. There is only one difference between the white light-emitting diode 100′ illustrated in FIG. 2B and the white light-emitting diode 100 illustrated in FIG. 2A. It is that the white light phosphor layer 108 in the white light-emitting diode 100 illustrated in FIG. 2A is a single layer structure but the white light phosphor layer 108′ in the white light-emitting diode 100′ illustrated in FIG. 2B is a multilayer structure.

Referring to FIG. 2B, the white light phosphor layer 108′ comprises several nano-phosphor material layers 108a, 108b, 108c, and the white light phosphor layer 108′ is a multilayer structure formed by stacking the nano-phosphor material layers 108a, 108b, 108c on the surface (inner surface or outer surface) of the lampshade 110. Several different nano-phosphor materials are respectively coated on the surface (inner surface or outer surface) of the lampshade 110 respectively for forming the nano-phosphor material layers 108a, 108b, 108c. For example, the blue light organic material and the zinc oxide nano structure are coated and stacked on the lampshade 110 to form a film having a multilayer structure, the blue light organic material, the zinc oxide nano structure, and the metal-ion-doped zinc sulfide nanoparticle are coated and stacked on the lampshade 110 to form a film having a multilayer structure, or the blue phosphor, the green phosphor, and the red phosphor are coated and stacked on the lampshade 110 to form a film having a multilayer structure.

The luminescent mechanism of the white light-emitting diode 100 illustrated in FIG. 2A and the white light-emitting diode 100′ illustrated in FIG. 2B are detailed as following: A UV light (or UV lights) is emitted by the UV LEDs 106 in the UV LED array 104 and the UV light (or UV lights) is emitted to the white light phosphor layer 108 having a single layer structure or the white light phosphor layer 108′ having a multilayer structure coated on the lampshade 110. Various nano-phosphor materials in the light phosphor layer 108, 108′ are excited by the UV light (or UV lights) to form various lights having different colors, for example blue light, green light, and red light. And then, the lights having different colors are mixed with each other to form a white light. It means that many pointolites (or point light sources) are formed by the nano-phosphor materials in the light phosphor layer 108, 108′ under the illumination of the UV light (or UV lights) for providing an all-dememtional illumination or a 360 degree illumination. The UV LED array 104 (or the UV LEDs 106) can efficiently provide the LTV lights toward all direction with the same intensity for generating a white light because the UV LEDs 106 are arranged in the UV LED array 104 to form an n-shaped array. Therefore, the UV light emit to the upside of the lampshade 110 of the white light-emitting diode 100, 100′ and the UV light emit to the other sides of the lampshade 110 of the white light-emitting diode 100, 100′ have the same intensity, and so the white light emitted from the upside of the white light-emitting diode 100, 100′ and the white light emitted from the other sides of the white light-emitting diode 100, 100′ have the same intensity. Furthermore, the color temperatures of the white light-emitting diode 100, 100′ are the same at all directions (or angles). Therefore, the white light-emitting diode 100, 100′ of the present invention can solves the problem that the white light of the conventional white LED has different intensity and color temperatures at different directions (or angles). Furthermore, the white light-emitting diode 100, 100′ of the present invention can provide a uniform white light having uniform intensity and uniform color temperature at all directions (or angles).

Furthermore, the phosphor(s) coated on the LED (such as a blue LED) of the conventional white LED is the location of the conventional white LED for emitting a white light. Therefore, the white light of the conventional white LED is shielded by the LED (such as a blue LED) itself or the base (or the pedestal) of the conventional white LED. It results in narrow angle intensity distribution and narrow illumination area of the conventional white LED. However, in the white light-emitting diode 100, 100′ of the present invention, the white light phosphor layer 108, 108′ is directly coated on the lampshade 110. Therefore, white light phosphor layer 108, 108′ is the location of the white light-emitting diode 100, 100′ of the present invention for emitting a white light, and the nano-phosphor material(s) at every location in the white light phosphor layer 108, 108′ is a pointolite (or point light source) for emitting a white light toward all directions. There are many pointolites (or point light sources) formed in the white light phosphor layer 108, 108′ because the nano-phosphor material(s) at every location in the white light phosphor layer 108, 108′. The shape arranged by these pointolites (or point light sources) is corresponded to (or the same with) the shape of the lampshade 110 because the white light phosphor layer 108, 108′ (or the nano-phosphor material(s)) is coated on surface of the lampshade 110 and these pointolites (or point light sources) is arranged on the surface of the lampshade 110. Therefore, the white light phosphor layer 108, 108′ (the white light-emitting diode 100, 100′) emits a white light corresponding to the shape of the lampshade 110 at all directions, and the white light is not shielded by the LED itself or the base of the white light-emitting diode 100, 100′. By this way, the white light-emitting diode 100, 100′ of the present invention can have wider angle intensity distribution and wider illumination area than the conventional white LED, and the problem of narrow angle intensity distribution and narrow illumination area of the conventional white LED can be solved and overcame. Therefore, the white light-emitting diode 100, 100′ of the present invention can provide a white light with wide angle intensity distribution and wide illumination area. Furthermore, the temperature of the white light phosphor layer 108, 108′ does not rise following the temperature rising of the UV LEDs 106 because the white light phosphor layer 108, 108′ are not directly coated or adhered on the UV LEDs 106. Therefore, the white light phosphor layer 108, 108′ will be not destroyed or invalidated by the rising temperature of the UV LEDs 106, and the white light-emitting diode 100, 100′ of the present invention can provide a stabe white light.

The white light phosphor layer 108, 108′ can be precisely controlled to have pre-determined thickness because the nano-phosphor material, of which the white light phosphor layer 108, 108′ is made, is nano-scaled, for example the blue light organic material, the zinc oxide nano structure, and the metal-ion-doped zinc sulfide nanoparticle in which the metal ion is capable of being used as a luminous center of a red light, the blue phosphor, the green phosphor, and the red phosphor. Even the white light phosphor layer 108, 108′ formed at all locations of the lampshade 100 can have the same thickness by these the nano-phosphor materials. These nano-phosphor materials are nano-scaled and they are small enough to have no absorbing effect to the white light generated by the white light-emitting diode 100, 100′ (or the white light phosphor layer 108, 108′). Therefore, the white light generated by the white light-emitting diode 100, 100′ will not become weaker and the illuminance of the white light-emitting diode 100, 100′ of the present invention will not become worse by the absorbing effect. Furthermore, the white light-emitting diode 100, 100′ of the present invention can provide a white light with good illuminance. The UV LEDs 106 in the UV LED array 104 are arranged to form an n-shaped array. By this n-shaped array, the UV LED array 104 provides UV lights having the same intensity toward all directions for generating a white light, and particularly the UV lights emitted to the upside and two sides (such as left side and right side) of the white light-emitting diode 100, 100′ have enough or the same intensity. As showed in FIG. 2A and FIG. 2B, the upside and the two sides (such as left side and right side) of the white light-emitting diode 100, 100′ respectively face light emitting surfaces of different LEDs 106. The UV light 105 emitted from the UV LEDs 106 on the upside of the UV LED array 104 is directly emitted to the upside of the white light-emitting diode 100, 100′, and the UV lights 107 emitted from the UV LEDs 106 on the two sides (such as left side and right side) of the UV LED array 104 is directly emitted to the two sides (such as left side and right side) of the white light-emitting diode 100, 100′. Therefore, the UV lights emitted to the upside and two sides (such as left side and right side) of the white light-emitting diode 100, 100′ can have enough or the same intensity. However, all UV lights emitted from the UV LEDs 106 are still directional, and each of the UV LEDs 106 emits a UV light only toward the direction facing it's own light emitting surface. Although, the UV LEDs 106 in the UV LED array 104 are arranged to form a n-shaped array, but there is no light emitting surface facing the corners of the n-shaped array. Therefore, only portions of the UV lights emitted from the UV LEDs 106 in n-shaped array (or the UV LED array 104) can indirectly emit to the locations of the white light phosphor layer 108, 108′ (or the lampshade 110), which face the corners of the n-shaped array (or the UV LED array 104), and so the intensity of the UV lights emitted to the locations of the white light phosphor layer 108, 108′ (or the lampshade 110), which face the corners of the n-shaped array (or the UV LED array 104), is lower than the intensity of the UV lights emitted to the locations of the white light phosphor layer 108, 108′ (or the lampshade 110) which directly face light emitting surfaces of the UV LEDs 106. However, comparing with the white lights emittef or generated from the locations of the white light phosphor layer 108, 108′ (or the lampshade 110) which directly face light emitting surfaces of the UV LEDs 106, the white lights emittef or generated from the locations of the white light phosphor layer 108, 108′ (or the lampshade 110), which face the corners of the n-shaped array (or the UV LED array 104), is weaker. Although this problem is not serious in the white light-emitting diode 100, 100′ of the present invention, but the present invention provides another embodiment of the white light-emitting diode with high uniformity and wide angle intensity distribution for solving above-mentioned problem of non-uniform intensity of the white light emitted from the white light-emitting diode.

Referring to FIG. 4, it is a drawing illustrating a white light-emitting diode 100A with high uniformity and wide angle intensity distribution in accordance with still another embodiment of the present invention. The white light-emitting diode 100A illustrated in FIG. 4 and the white light-emitting diode 100 illustrated in FIG. 2A have similar structures. Similarly, the white light-emitting diode 100A also comprises a base 102, a UV LED array 104, a white light phosphor layer 108A, and a lampshade 110. There is only one difference between the white light-emitting diode 100A illustrated in FIG. 4 and the white light-emitting diode 100 illustrated in FIG. 2A. The only difference is that in the white light-emitting diode 100A, the thicknesses of the white light phosphor layer 108A at the locations 109, which do not face or correspond to any light emitting surfaces of the UV LEDs 106 (such as the corners of the UV LED array 104), are thinner than the thicknesses of the white light phosphor layer 108A at other locations, which directly face or correspond to light emitting surfaces of the UV LEDs 106. In other words, the thickness of the white light phosphor layer 108A on the locations which has high light field strength provided by the UV LED array 104 is thicker, and the thickness of the white light phosphor layer 108A on the locations 109 which has low light field strength provided by the UV LED array 104 is thinner. It means that the white light phosphor layer 108A at different locations of the lampshade 110 has different thicknesses according to light field strength provided by the UV LED array 104. The higher light field strength the UV LED array 104 provides to the location on the surface of the lampshade 110 (or the white light phosphor layer 108A), the thicker thickness the white light phosphor layer 108A at this location has. The lower light field strength the UV LED array 104 provides to the location 109 on the surface of the lampshade 110 (or the white light phosphor layer 108A), the thinner thickness the white light phosphor layer 108A at this location 109 has. Therefore the white light phosphor layer 108A at the location 109 can be excited by a UV light with lower light field strength to emit a white light having the same light field strength and intensity with the white light emitted from the other locations of the lampshade 110 (or the white light phosphor layer 108A), such as the upside of the lampshade 110. By this way, the white light-emitting diode 100A of the present invention can provide a white light with high uniformity (such as uniform intensity and uniform color temperature). The ratio of the thickness of the white light phosphor layer 108A on the location of the surface of the lampshade 110 having highest light field strength provided by the UV LED array 104 and the thickness of the white light phosphor layer 108A on the location 109 of the surface of the lampshade 110 having lowest light field strength provided by the UV LED array 104 is 1 to 50.

Besides, referring to FIG. 3A, the present invention also provides a planar white light-emitting diode 200 with high uniformity and wide angle intensity distribution. The planar white light-emitting diode 200 illustrated in FIG. 3A and the white light-emitting diode 100 illustrated in FIG. 2A have similar structures. Similarly, the planar white light-emitting diode 200 also comprises a base 202, a UV LED array 204, a white light phosphor layer 208, and a lampshade 210. The materials and the features of the base 202, the UV LED array 204, the white light phosphor layer 208, and the lampshade 210 of the white light-emitting diode 200 are similar to the base 102, the UV LED array 104, the white light phosphor layer 108, and the lampshade 110 of the white light-emitting diode 100, and they are described in detail above. Therefore, they are not mentioned herein again. The differences between the planar white light-emitting diode 200 illustrated in FIG. 3A and the white light-emitting diode 100 illustrated in FIG. 2A is that the UV LEDs 206 are arranged in the UV LED array 206 of the planar white light-emitting diode 200 to form a planar array and the lampshade 210 is a planar lampshade. In the planar white light-emitting diode 200, all of the light emitting surfaces of the UV LEDs 206 face the planar side (or the upside) of the lampshade 210 (or the planar white light-emitting diode 200) because of the planar shape of the UV LED array 204. All of the UV lights 205 emitted from the UV LED array 204 are emitted to the planar side (or the upside) of the lampshade 210 (or the planar white light-emitting diode 200). As a consequence, the planar white light-emitting diode 200 illustrated in FIG. 3A can not provide a white light having wide angle intensity distribution and wide illumination area the same with the white light-emitting diode 100 illustrated in FIG. 2A. However, like the white light-emitting diode 100 illustrated in FIG. 2A, the planar white light-emitting diode 200 illustrated in FIG. 3A also can provide a stable white light with high uniformity (such as uniform intensity and uniform color temperature), wide angle intensity distribution, and good illuminance because the luminescent mechanisms and luminescent principles of the planar white light-emitting diode 200 illustrated in FIG. 3A and the white light-emitting diode 100 illustrated in FIG. 2A are the same. Furthermore, like the white light-emitting diode 100 illustrated in FIG. 2A, the color temperature of the planar white light-emitting diode 200 can be controlled, changed and adjusted by changing or adjusting the ratio of compositions (or the nano-phosphor materials) of the white light phosphor layer 208 and the temperature for annealing the white light phosphor layer 208.

Although the white light phosphor layer 208 of the planar white light-emitting diode 200 illustrated in FIG. 3A is a single layer structure, but the white light phosphor layer of the planar white light-emitting diode of the present invention can be a multilayer structure as the white light phosphor layer 208′ of the planar white light-emitting diode 200′ illustrated in FIG. 3B. The white light phosphor layer 208′ is formed by stacking several layers of different nano-phosphor materials.

According to foregoing embodiments, the present invention provides a white light-emitting diode with high uniformity and wide angle intensity distribution. In the white light-emitting diode, there are many pointolites (or point light sources) formed on the lampshade by the white light phosphor layer, which is formed by coating the nano-phosphor material on the surface of the lampshade, when a UV light illuminates the white light phosphor layer. Therefore, the white light-emitting diode can provide a stable white light with big illumination area, uniform intensity and color temperature, and good illuminance. Further, the color temperature of the white light generated by the white light-emitting diode can be adjusted by different combinations of the UV LEDs respectively having different wavelengths, and different ratio of compositions of white light phosphor layer.

What is claimed is:

1. A white light-emitting diode with high uniformity and wide angle intensity distribution, comprising:
a base;
a UV LED array deposed on the base;
a lampshade integrated with the base to form a space inside the combination of the lampshade and the base wherein the space holds or contains the UV LED array therein; and
a white light phosphor layer coated on one surface of the lampshade wherein the white light phosphor layer is made of a nano-phosphor material.

2. The white light-emitting diode of claim 1, wherein the base comprises a heat dissipation device.

3. The white light-emitting diode of claim 2, wherein the heat dissipation device is a heat dissipation paint, a heat sink, a carbon nanotube, or a copper-aluminum alloy.

4. The white light-emitting diode of claim 1, wherein the UV LED array comprises a plurality of UV LEDs and each of the UV LEDs emits a UV light having wavelength in range of 100 nm to 399 nm.

5. The white light-emitting diode of claim 4, wherein the UV LED array comprises a single set of UV LEDs which emit a UV light having a specific wavelength.

6. The white light-emitting diode of claim 4, wherein the UV LED array comprises at least two set of UV LEDs and the at least two set of UV LEDs emit UV lights having different wavelengths respectively for controlling or adjusting color temperature of the white light-emitting diode.

7. The white light-emitting diode of claim 4, wherein the UV LEDs in said UV LED array are arranged to form a linear array, a n-shaped array, a semicircular array, or a circular array.

8. The white light-emitting diode of claim 1, wherein the lampshade has a planar shape, a spherical shape, an elliptic shape, or a circular-arc shape.

9. The white light-emitting diode of claim 1, wherein the lampshade is made of glass, PMMA, PET, PP, PU, PE, PC, or PS.

10. The white light-emitting diode of claim 1, wherein the lampshade is made of a flexible material.

11. The white light-emitting diode of claim 1, wherein the white light phosphor layer is a single layer structure.

12. The white light-emitting diode of claim 11, wherein the nano-phosphor material comprises a blue light organic material and a zinc oxide nano structure, and the white light phosphor layer is a film formed by mixing the blue light organic material with the zinc oxide nano structure.

13. The white light-emitting diode of claim 12, wherein emitting characters of said white light-emitting diode are changed or adjusted by changing ratio between said blue light organic material with said zinc oxide nano structure.

14. The white light-emitting diode of claim 12, wherein the nano-phosphor material comprises a blue light organic material, a zinc oxide nano structure, and a metal-ion-doped zinc sulfide nanoparticle in which the metal ion is capable of being used as a luminous center of a red light, and the white light phosphor layer is a film formed by mixing the blue light organic material, the zinc oxide nano structure, and the metal-ion-doped zinc sulfide nanoparticle.

15. The white light-emitting diode of claim 14, wherein the metal ion is a manganese ion, iron ion, cobalt ion, or copper ion.

16. The white light-emitting diode of claim 14, wherein color temperature of the white light-emitting diode are changed or adjusted by changing or adjusting annealing temperature of the white light phosphor layer.

17. The white light-emitting diode of claim 11, wherein the nano-phosphor material comprises a blue phosphor, a green phosphor, and a red phosphor, and the white light phosphor layer is a film formed by mixing the blue phosphor, the green phosphor, and the red phosphor.

18. The white light-emitting diode of claim 1, wherein the white light phosphor layer is a multilayer structure.

19. The white light-emitting diode of claim 18, wherein the nano-phosphor material comprises a blue light organic material and a zinc oxide nano structure, and the white light phosphor layer comprises a layer of the blue light organic material and a layer of the zinc oxide nano structure, and the white light phosphor layer is formed by stacking the layer of said blue light organic material and the layer of said zinc oxide nano structure.

20. The white light-emitting diode of claim 18, wherein the nano-phosphor material comprises a blue phosphor, a green phosphor, and a red phosphor, and the white light phosphor layer comprises a layer of the blue phosphor, a layer of the green phosphor, and a layer of the red phosphor, and the white light phosphor layer is formed by stacking the layer of said blue phosphor, the layer of said green phosphor, and the layer of said red phosphor.

21. The white light-emitting diode of claim 1, wherein the nano-phosphor material is coated on the surface of the lampshade by spin coating, dip coating, ink printing, thermal evaporation, sputtering, spray coating, or roll-to-roll.

22. The white light-emitting diode of claim 1, wherein different locations on the surface of the lampshade have different thickness of the white light phosphor layer based on light field strength provided by the UV LED array.

23. The white light-emitting diode of claim 22, wherein the thickness of the white light phosphor layer on the location which has high light field strength provided by the UV LED array is thicker, and the thickness of the white light phosphor layer on the location which has low light field strength provided by the UV LED array is thinner.

24. The white light-emitting diode of claim 23, wherein ratio of the thickness of the white light phosphor layer on the location having highest light field strength provided by the UV LED array and the thickness of the white light phosphor layer on the location having lowest light field strength provided by the UV LED array is 1 to 50.
